(19) United States
(12) Patent Application Publication
(10) Pub. No.: US 2008/0002832 A1
(43) Pub. Date: Jan. 3, 2008

(54) METHODS OF DETECTING AN ABNORMAL OPERATION OF PROCESSING APPARATUS AND SYSTEMS THEREOF

(75) Inventors: Jain-Hong Chen, Miaoli County (TW); Mu-Tsang Lin, Changhua County (TW); W. L. Huang, Chiayi County (TW)

Correspondence Address: DUANE MORRIS LLP;IP DEPARTMENT (TSMC), 30 SOUTH 17TH STREET, PHILADELPHIA, PA, 19103-4196, US

(73) Assignee: TAIWAN SEMICONDUCTOR MANUFACTURING CO., LTD., Hsin-Chu (TW)

(21) Appl. No.: 11/470,469

(22) Filed: Sep. 6, 2006

Related U.S. Application Data
(60) Provisional application No. 60/806,205, filed on Jun. 29, 2006.

(51) Int. Cl. H04R 29/00

(52) U.S. Cl. 381/56

(57) ABSTRACT

A method for detecting abnormal operation of a manufacturing process, comprising the steps of: (a) detecting at least one acoustic signal created from a processing apparatus; (b) transforming the acoustic signal into a frequency spectrum; (c) comparing the frequency spectrum with a pre-determined frequency spectrum, and (d) generating a signal indicating an abnormal operation of the processing apparatus, if an amplitude of at least one first frequency of the frequency spectrum is substantially different from an amplitude of the same frequency of the pre-determined frequency spectrum.

### CROSS REFERENCE

The present application is a non-provisional and claims the benefit of U.S. Provisional Application No. 60/806,205, filed on Jun. 29, 2006, which application is hereby incorporated by reference herein in its entirety.

### BACKGROUND OF THE INVENTION

1. Field of the Invention

The present invention relates to methods of detecting an abnormal operation of a semiconductor processing apparatus and systems for performing the method.

2. Description of the Related Art

With advances associated with electronic products, semiconductor technology has been widely applied in manufacturing memories, central processing units (CPUs), liquid crystal displays (LCDs), light emission diodes (LEDs), laser diodes and other devices or chip sets. In order to achieve high-integration and high-speed goals, dimensions of semiconductor integrated circuits continue to shrink. Various materials and techniques have been proposed to achieve these integration and speed goals and to overcome manufacturing obstacles associated therewith. Due to high integration, even a minor scratch, damage or particle formed over a wafer substrate by an abnormal operation of a processing apparatus may adversely affect yield of the manufacturing process. In order to resolve the problem, an alarm system for detecting an abnormal operation of a processing apparatus has been used.

For example, a track system is provided to coat a photoresist layer over a wafer substrate. The track system usually comprises a robotic system that is configured to translate a wafer (or wafers) within the track system into and out of the track system. In some situations, the robot translates a wafer from a processing chamber disposed within the track system to a slot of a cassette which carries multiple wafers, or vice versa. In one aspect, adjacent slots within a cassette are designed close enough so that the size of the cassette can be reduced and a storage facility can accommodate more cassettes with the desirably designed slots. In another aspect, the space between adjacent slots within a cassette must be well designed so that a blade of the robot can move into the cassette and translate a wafer without damage, such as scratching or bumping, to another wafer therebelow. Accordingly, the robotic system for translating wafers into and out of a cassette must be well designed to avoid at least the concern described above.

In order to avoid abnormal operation of the robot that may damage wafers, as set forth above, alignment sensors are disposed within the track system to detect whether the robot properly translates in a way that does not substantially damage either the carried wafer or other wafers stored within the cassette. If the sensors detect that the robot does not move in a pre-determined way, the operation of the track system may be delayed for further investigation or correction.

However, the alignment sensors may not be sensitive enough to detect a minor deviation of the robot. A minor deviation of the robot may not cause serious damage to the wafers, but may cause scratches on surfaces of the wafers. As explained above, a minor scratch may substantially reduce the yield of highly integrated circuits formed over the wafers. Further, because the alignment sensors fail to detect the minor deviation of the robot, subsequent wafers stored in other cassettes may be processed by the same track system and translated by the same robot until the scratches formed on the wafers are found.

U.S. Patent Publication No. 2003/0075936 provides a description of a wafer blade including a strain sensor provided to avoid wafer scratching, the entirety of which is also hereby incorporated by reference herein.

From the foregoing, improved methods and systems are desired.

### SUMMARY OF THE INVENTION

In accordance with some exemplary embodiments, a method for detecting abnormal operation of a manufacturing process, comprises the steps of: (a) detecting at least one acoustic signal created from a processing apparatus; (b) transforming the acoustic signal into a frequency spectrum; (c) comparing the frequency spectrum with a pre-determined frequency spectrum, and (d) generating a signal indicating an abnormal operation of the processing apparatus, if an amplitude of at least one first frequency of the frequency spectrum is substantially different from an amplitude of the same frequency of the pre-determined frequency spectrum.

In accordance with some exemplary embodiments, a system for detecting abnormal operation of a manufacturing process comprises a detector, a processor and a memory. The detector is configured to detect at least one acoustic signal from a processing apparatus and output an electrical signal representative of the acoustic signal. The processor is coupled to the detector and configured to transform the acoustic signal into a frequency spectrum. The memory is coupled to at least one of the detector and processor. The memory is configured to store the frequency spectrum and a pre-determined frequency spectrum. The processor compares the frequency spectrum with the pre-determined frequency spectrum. If an amplitude of a first frequency of the frequency spectrum is substantially different from an amplitude of a corresponding frequency of the pre-determined frequency spectrum, the processor generates a signal to indicate an abnormal operation of the processing apparatus.

The above and other features of the present invention will be better understood from the following detailed description of the preferred embodiments of the invention that is provided in connection with the accompanying drawings.

### BRIEF DESCRIPTION OF THE DRAWINGS

Following are brief descriptions of exemplary drawings. They are mere exemplary embodiments and the scope of the present invention should not be limited thereto.

FIG. 1 is a block diagram of an exemplary system coupled to a processing apparatus for detecting abnormal operation of a processing apparatus.

FIG. 2 is a flow chart showing an exemplary method for detecting abnormal operation of a processing apparatus.

FIGS. 3A and 3B are diagrams showing signal spectrums before and after a spectrum transform, respectively.

FIGS. 4A and 4B are diagrams showing spectrums before and after weighting factors are multiplied with amplitudes of signals at different frequencies, respectively.

FIGS. 5A and 5B are diagrams showing a pre-determined frequency spectrum corresponding to a normal operation of a processing apparatus and a frequency spectrum corresponding to an abnormal operation of the processing apparatus, respectively.

### DESCRIPTION OF THE PREFERRED EMBODIMENT

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation.

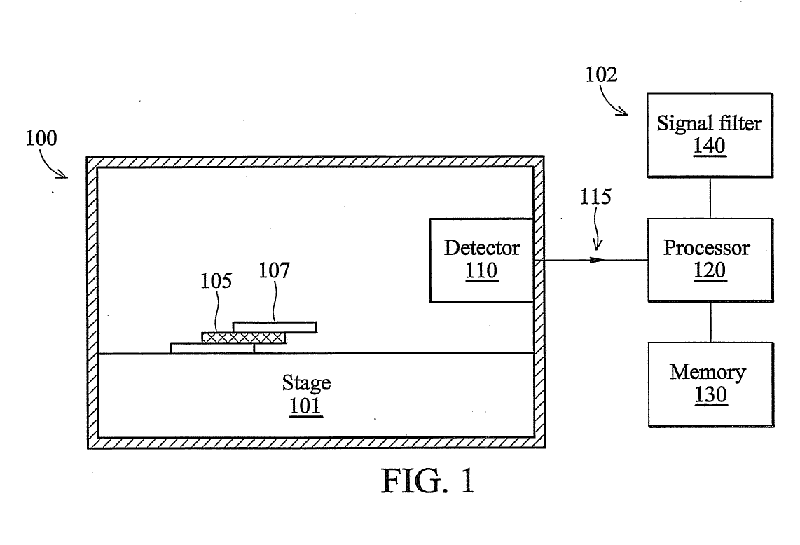

FIG. 1 is a block diagram showing an exemplary system 102 coupled to a processing apparatus 120 for detecting abnormal operation of a manufacturing process.

The exemplary system 102 for detecting abnormal operation of a manufacturing process comprises a detector 110, a processor 120 and a memory 130, for example. The detector 110 is coupled to the processor 120. The memory 130 is coupled to at least one of the detector 110 and processor 120. The detector 110 may be, for example, an acoustic detector, microphone (e.g., capacitor microphone, condenser microphone, electric capacitor microphone, dynamic microphone, ribbon microphone, carbon microphone, piezo microphone, laser microphone or other type of microphone), piezoelectric device, sensor or other detector that is capable of detecting a sound signal. The processor 120 may comprise, for example, at least one of a digital signal processor (DSP), microprocessor, computer or a combination thereof. The memory 130 may comprise, for example, at least one of a random access memory (RAM), floppy diskettes, read only memories (ROMs), flash drive, CD-ROMs, DVD-ROMs, hard drives, high density (e.g., “ZIPT”) removable disks or any other computer-readable storage medium.

The system 102 is coupled to a processing apparatus 100. In some embodiments, the processing apparatus 100 may be a semiconductor manufacturing apparatus, such as a substrate transportation system, a thin film system (e.g., chemical vapor deposition (CVD) system, physical vapor deposition (PVD) system or electrochemical plating system), an etch system (e.g., wet etch bath or dry etch system), a chemical mechanical polishing (CMP) system, a photolithographic system (e.g., track, stepper or photoresist removal system), a diffusion system (e.g., implanter, furnace or rapid thermal anneal (RTA) system), a system for measuring physical characteristics (e.g., depth, thickness or width of a film or opening), a system for calibrating electrical characteristics (e.g., wafer acceptance test (WAT) system), an inspection system (e.g., an optical microscope (OM) or scanning electron microscope (SEM)), a system for testing product reliability or other apparatus or system related to semiconductor manufacturing.

For example, the processing apparatus 100, such as a track system, comprises a stage 101, a substrate delivery system 105 and a plurality of processing chambers (not shown). The stage 101 is disposed within the processing apparatus 100 for supporting the substrate delivery system 105. In some embodiments, the substrate delivery system 105 is configured over the stage 101 for translating a substrate, e.g., substrate 107. The substrate delivery system 105 may comprise, for example, a robot or other system that is able to translate the substrate 107 within the processing apparatus 100 and translate the substrate 107 into or out of the processing apparatus 100. The substrate 107 can be a silicon substrate, III-V compound substrate, display substrate such as a liquid crystal display (LCD), plasma display, cathode ray tube display or electro luminescence (EL) lamp display, or light emitting diode (LED) substrate (collectively referred to as, substrate 107), for example.

The detector 110 may be disposed within or on the processing apparatus 100 to detect at least one acoustic signal 115, such as a sound or noise, created from the processing apparatus 100. The acoustic signal 115 is of a type that can be represented in time series form. In some embodiments, the detector 110 is disposed near to, but not attached to, the processing apparatus 100, as long as the detector can desirably detect the acoustic signal 115 caused by an abnormal operation of the processing apparatus 100. The acoustic signal 115 may comprise, for example, at least a sound of wafer scratching, wafer cracking, wafer smashing, wafer dropping, wafer bumping, friction of components (e.g., a blade and a robot arm or any two components of the processing apparatus 100) of the processing apparatus 100, bumping of components (e.g., a blade and a wall of the processing apparatus 100 or any two components of the processing apparatus 100) of the processing apparatus 100, mechanical aging of at least one component of the processing apparatus 100 and other abnormal operation of the processing apparatus 100.

The memory 130 is configured to store a pre-determined frequency spectrum corresponding to a normal operation of the processing apparatus 100 and a frequency spectrum corresponding to an abnormal operation of the processing apparatus 100. As set forth above, at least one acoustic signal caused during the operation of the process apparatus 100 is detected by the detector 110. A detailed description of a method for generating the pre-determined frequency spectrum and frequency spectrum is provided below.

In some embodiments, the system 102 for detecting an abnormal operation of the processing apparatus 100 further comprises a signal filter 140. The signal filter 140 may be coupled to at least one of the processor 120 and memory 130 to filter at least one component of the frequency spectrum. Detailed description of filtering the noise is provided below.

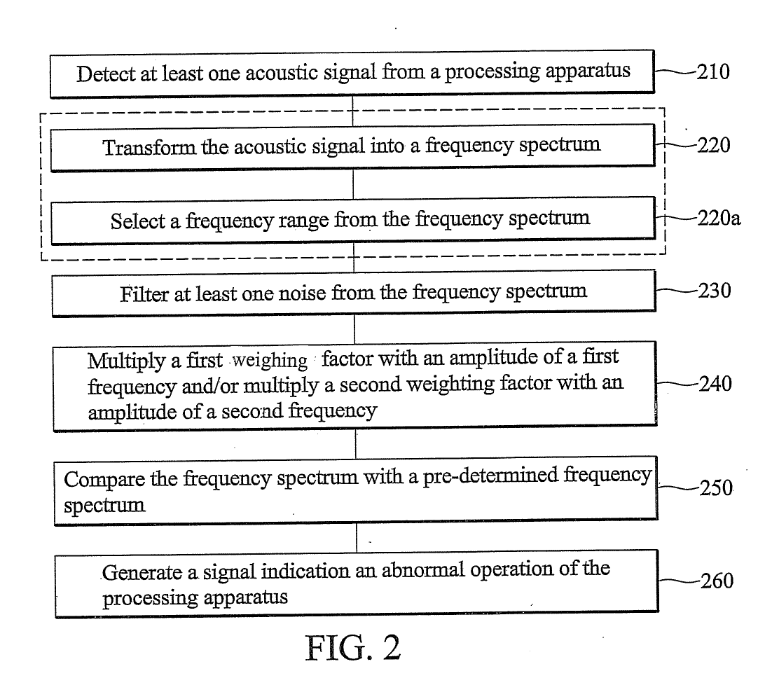

FIG. 2 is a flow chart showing an exemplary method for detecting an abnormal operation of a processing apparatus.

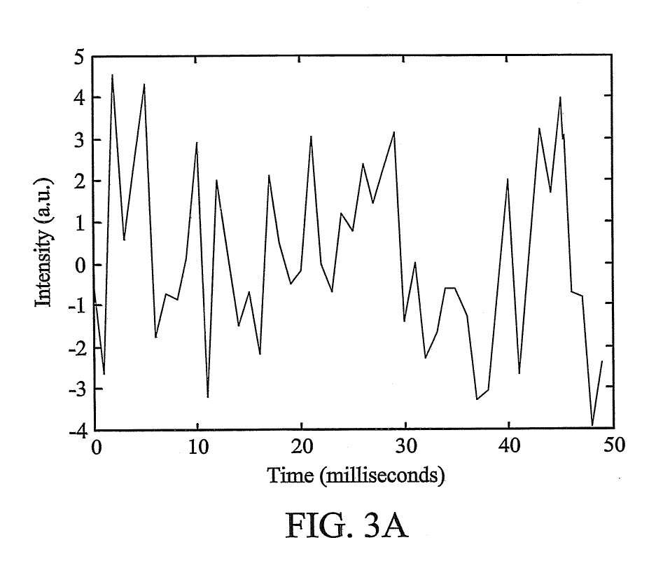

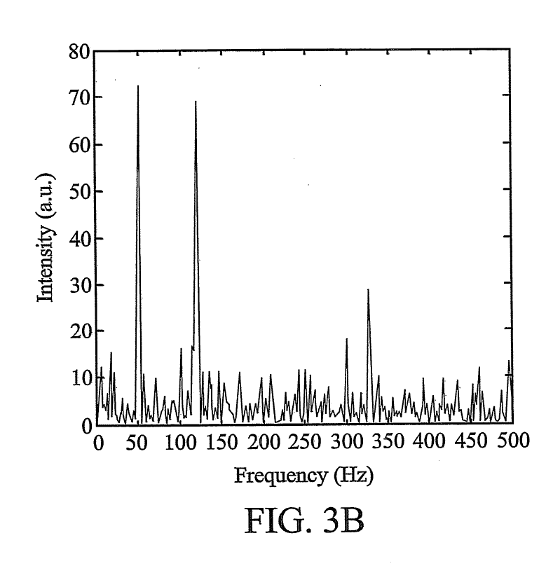

In Step 210, the detector 110 (shown in FIG. 1) detects at least one acoustic signal 115 created from the processing apparatus 100 (shown in FIG. 1). A signal representing the detected acoustic signal 115 is then transmitted to the processor 120 (shown in FIG. 1). The profile of the acoustic signal 115 can be expanded in frequency and amplitude as shown in FIG. 3A. As set forth above, the acoustic signal 115 may comprise various sounds or noises created by an abnormal operation of the processing apparatus 100. Based on this profile, it is difficult to identify frequencies or corresponding amplitudes of the sound signal.

In Step 220, the processor 120 may transform the acoustic signal 115 into a frequency spectrum, for example, by Fourier transform, Laplace transform, wavelet transform or other transform that is able to decompose a signal into frequency and amplitude components. For example, the transformation of the acoustic signal 115 can be performed by an exemplary Fourier transform formula as shown below:

$$f ( t ) = 1 / \sqrt{2 π} {\int }_{- ∞}^{∞} F ( ω ) {e}^{iω t} d ω$$

wherein f(t) represents the profile shown in FIG. 3A in; F(w) represents the profile shown in FIG. 3B; and w represents angular frequency.

After the transformation, amplitudes of some specified frequencies corresponding to an abnormal operation of the processing apparatus 100 can be desirably identified as shown in FIG. 3B. Accordingly, it is easier to identify whether the operation of the process apparatus 100 is normal or abnormal based upon the frequency spectrum.

In some embodiments, Step 220 further comprises Step 220a. In Step 220a, the processor 120 is configured to select a frequency range from the frequency spectrum. This step is provided to reduce the processing time for Fourier transform. In some embodiments, the frequency range selected by the processor 120 is between about 1,000 Hertz (1 kHz) and about 10,000 (10 kHz). With this range of frequencies included in a sound signal created from a contact between the substrate 107 (shown in FIG. 1) and another object can be easily found, such as wafer scratching, wafer cracking, wafer smashing, wafer dropping, wafer bumping or other abnormal operation that creates an acoustic signal from the contact of the substrate 107 and an object (e.g., cassette, another substrate, robot 105 or any object within and/or on the processing apparatus 110). Compared with a method of generating a frequency spectrum which extends the frequency range to hundreds of MHz, the selection of the frequency range may substantially reduce the processing time of Step 220. In some embodiments, however, Step 220a is omitted because the processing time of generating the hundreds-of-MHz frequency spectrum is not a concern.

In Step 230, the signal filter 140 (shown in FIG. 1) filters at least one component from the frequency spectrum shown in FIG. 3B. In some embodiments, Step 230 of filtering noise can be performed by the processor 120, and thus the signal filter 140 may be omitted. In other embodiments, when noise will not obscure the frequencies caused by an abnormal operation of the processing apparatus 100, Step 230 and the signal filter 140 can also be omitted.

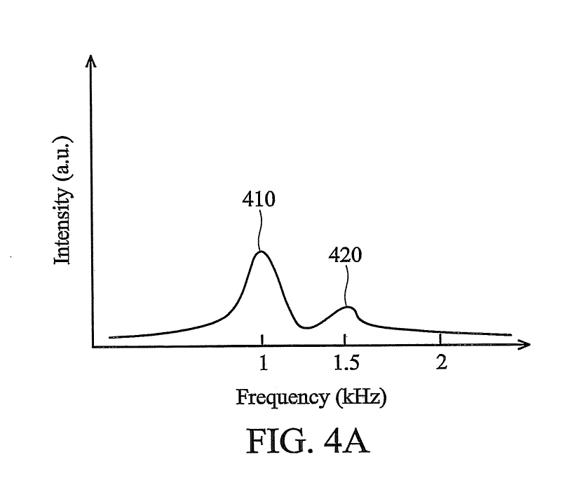

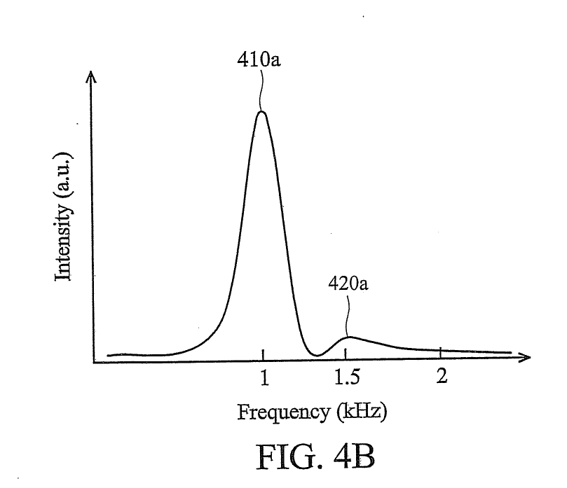

In Step 240, the processor 120 further multiplies a first weighting factor with an amplitude of a first frequency of the frequency spectrum and/or multiplies a second weighting factor with an amplitude of a second frequency of the frequency spectrum, thereby emphasizing the first frequency included in the acoustic signal 215 corresponding to any abnormal operation of the processing apparatus 100 as set forth above. For example, FIG. 4A shows that a signal 410 at a frequency of about 1 kHz is created corresponding to an abnormal operation of the processing apparatus 100, and that a noise signal 420 at about frequency 1.5 kHz is also present. The noise signal 420 does not correspond to the frequency created by an abnormal operation of the processing apparatus 100. Reducing or removing the noise signal 420 will be helpful in collecting and recognizing the desired signal, such as the signal 410, indicating the abnormal operation of the apparatus 100. By either or both of multiplying weighting factors with the amplitudes of the signals 410 and 420, the signal 410a can be emphasized more than the signal 420a as shown in FIG. 4B. In some embodiments, the first weighting factor can be between about ten and about several hundreds. The second weighting factor can be between about one tenth and about one several-hundredth. The first and second weighting factors are acceptable as long as the signal 410a is emphasized enough, compared with other signal (e.g., the signal 420a), so that the signal 410a can be desirably identified by the processor 120. In other embodiments, Step 240 is omitted because the original signal 410 is emphasized enough to be differentiated from other signals, such as the original signal 420, without multiplying the weighting factors.

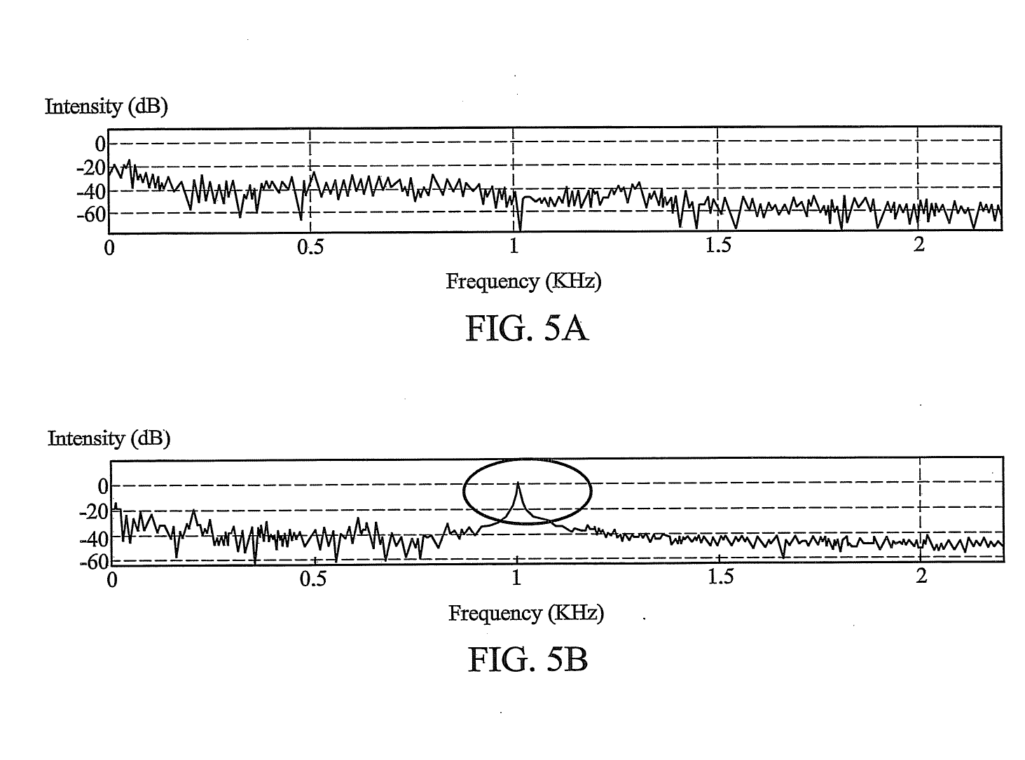

In Step 250, the processor 120 compares the frequency spectrum as shown in FIG. 5B with the pre-determined frequency spectrum as shown in FIG. 5A. As set forth above, the pre-determined frequency spectrum as shown in FIG. 5A is analyzed and decomposed from an acoustic signal which is detected while the processing apparatus 100 is under a normal operation. The process of decomposing the acoustic signal to generate the pre-determined frequency spectrum may comprise Steps 210, 220, 220a, 230 and/or 240. For a pre-determined frequency spectrum obtained from Step 240, because the pre-determined frequency spectrum does not include the signal 410 corresponding to an abnormal operation of the processing apparatus, multiplying the first weighting factor with the amplitude of the signal 410 can be omitted.

By comparing the frequency spectrum obtained in Step 220, 220a, 230 or 240 with the corresponding pre-determined frequency spectrum generated from Step 220, 220a, 230 and 240, respectively, the presence of the frequency included in the sound signal 115 that is caused by an abnormal operation of the processing apparatus 100 can be identified.

In Step 260, the processor 120 generates a signal to indicate an abnormal operation of the processing apparatus 100, if the amplitude of the frequency (e.g. 1 kHz) of the frequency spectrum (shown in FIG. 5B) is substantially higher than that of the corresponding frequency (e.g., 1 kHz) of the pre-determined frequency spectrum (shown in FIG. 5A). In some embodiments, the signal may be transmitted to a component, e.g., an actuator (not shown), of the processing apparatus 100 to prevent the processing apparatus 100 from performing any process until an investigation and/or correction is made.

Although the examples described above detect the presence of a frequency component having an amplitude significantly larger than the pre-determined frequency spectrum, in other embodiments, a frequency component may be detected that is significantly smaller than the predetermined spectrum. For example, if the detected frequency spectrum and the pre-determined frequency spectrum are both normalized, the system may detect a very low amplitude component as a sign of an abnormal condition. This may be used, for example, where the process normally produces an ambient noise, and the absence of one or more components of the ambient noise indicates an abnormality in the process.

In some embodiments, the respective amplitudes of two or more frequency components of the detected frequency spectrum are compared with the respective frequency components of the pre-determined frequency spectrum. The presence of one or more components that are significantly different from (i.e., components larger than and/or components smaller than) the predetermined spectrum components result in detection of an abnormal condition.

From the foregoing, the system 102 and method described above can desirably detect and transform the sound signal into a frequency spectrum. By identifying at least one frequency of the frequency spectrum, an abnormal operation of the processing apparatus 100, such as the presence of a minor scratch on the substrate 107, can be readily detected. The cause of the problem is then investigated, and any processing of subsequent substrates stored in other cassettes is held until the investigation is completed. Therefore, damages to the other substrates that might be caused by the same abnormal operation of the process apparatus 107 can be avoided.

Although the present invention has been described in terms of exemplary embodiments, it is not limited thereto. Rather, the appended claims should be construed broadly to include other variants and embodiments of the invention which may be made by those skilled in the field of this art without departing from the scope and range of equivalents of the invention.

What is claimed is:

1. A method for detecting abnormal operation of a manufacturing process, comprising the steps of:
(a) detecting at least one acoustic signal created from a processing apparatus;
(b) transforming the acoustic signal into a frequency spectrum;
(c) comparing the frequency spectrum with a pre-determined frequency spectrum, and
(d) generating a signal indicating an abnormal operation of the processing apparatus, if an amplitude of at least one first frequency of the frequency spectrum is substantially different from an amplitude of the same frequency of the pre-determined frequency spectrum.

2. The method of claim 1, wherein the acoustic signal comprises at least a sound of wafer scratching, wafer cracking, wafer smashing, wafer dropping, wafer bumping, bumping of components of the processing apparatus, mechanical aging of at least one components of the processing apparatus and other abnormal operation of the processing apparatus.

3. The method of claim 1, wherein step (b) is performed by Fourier transform.

4. The method of claim 3 further comprising at least one of the group consisting of:
multiplying a first weighting factor with the amplitude of the first frequency of the frequency spectrum; and
multiplying a second weighting factor with an amplitude of a second frequency of the frequency spectrum.

5. The method of claim 1 further comprising filtering at least one noise from the frequency spectrum.

6. The method of claim 1, wherein step (b) further comprises selecting a frequency range from the frequency spectrum.

7. The method of claim 6, wherein the frequency range of the frequency spectrum is between about 1,000 Hertz (1 kHz) and about 10 kHz.

8. The method of claim 1, wherein the pre-determined frequency spectrum corresponds to a normal operation of the processing apparatus.

9. A method for detecting abnormal operation of a semiconductor manufacturing process, comprising the steps of:
(a) detecting at least one acoustic signal created from a semiconductor processing apparatus;
(b) transforming the acoustic signal into a frequency spectrum by Fourier transform;
(c) filtering at least one noise from the frequency spectrum;
(d) selecting a frequency range from the frequency spectrum;
(e) comparing components within the selected frequency range of the frequency spectrum with components in a pre-determined frequency spectrum, and
(d) generating a signal indicating an abnormal operation of the processing apparatus, if an amplitude of a first frequency of the frequency spectrum is substantially different from an amplitude of the same frequency of the pre-determined frequency spectrum.

10. The method of claim 9, wherein the acoustic signal comprises at least a sound of wafer scratching, wafer cracking, wafer smashing, wafer dropping, wafer bumping, bumping of components of the processing apparatus, mechanical aging of at least one components of the processing apparatus and other abnormal operation of the processing apparatus.

11. The method of claim 9 further comprising at least one of:
multiplying a first weighting factor with the amplitude of the first frequency of the frequency spectrum; and
multiplying a second weighting factor with an amplitude of at least one second frequency of the frequency spectrum.

12. The method of claim 9, wherein the frequency range of the frequency spectrum is between about 1,000 Hertz (1 kHz) and about 10 kHz.

13. The method of claim 9, wherein the pre-determined frequency spectrum corresponds to a normal operation of the processing apparatus.

14. A system for detecting abnormal operation of a manufacturing process, comprising:
a detector configured to detect at least one acoustic signal created from a processing apparatus and output an electrical signal representative of the acoustic signal;
a processor coupled to the detector and configured to transform the electrical signal into a frequency spectrum; and
a memory coupled to at least one of the detector and processor, the memory being configured to store the frequency spectrum and a pre-determined frequency spectrum,
wherein the processor compares the frequency spectrum with the pre-determined frequency spectrum, and
wherein if an amplitude of at least one first frequency of the frequency spectrum is substantially different from an amplitude of a corresponding frequency of the pre-determined frequency spectrum, the processor generates a signal to inform an abnormal operation of the processing apparatus.

15. The system of claim 14, wherein the acoustic signal comprises at least a sound of wafer scratching, wafer cracking, wafer crashing, wafer dropping, wafer bumping, bumping of components of the processing apparatus, mechanical aging of at least one components of the processing apparatus and other abnormal operation of the processing apparatus.

16. The system of claim 14, wherein the processor comprises a digital signal processor (DSP) configured to perform a Fourier transform to transform the acoustic signal.

17. The system of claim 14, wherein the processor further performs at least one step of:
multiplying a first weighting factor with the amplitude of the first frequency of the frequency spectrum; and
multiplying a second weighting factor with an amplitude of at least one second frequency of the frequency spectrum.

18. The system of claim 14 further comprising a signal filter coupled to at least one of the processor and the memory and configured to filter at least one noise of the frequency spectrum.

19. The system of claim 14, wherein the process further selects a frequency range between about 1,000 Hertz (1 kHz) and about 10 kHz from the frequency spectrum.

20. The system of claim 14, wherein the pre-determined frequency spectrum corresponds to a normal operation of the processing apparatus.
